(19) United States
(12) Patent Application Publication
(10) Pub. No.: US 2022/0101852 A1
(43) Pub. Date: Mar. 31, 2022

(54) CONVERSATION SUPPORT DEVICE, CONVERSATION SUPPORT SYSTEM, CONVERSATION SUPPORT METHOD, AND STORAGE MEDIUM

(71) Applicant: HONDA MOTOR CO., LTD., Tokyo (JP)

(72) Inventors: Kazuhiro Nakadai, Wako-shi (JP); Naoaki Sumida, Wako-shi (JP); Masaki Nakatsuka, Wako-shi (JP); Yuichi Yoshida, Wako-shi (JP); Takashi Yamauchi, Wako-shi (JP); Kazuya Maura, Hayami-gun (JP); Kyosuke Hineno, Hayami-gun (JP); Syozo Yokoo, Hayami-gun (JP)

(21) Appl. No.: 17/478,980

(22) Filed: Sep. 20, 2021

(30) Foreign Application Priority Data
Sep. 30, 2020 (JP) 2020-164422

(51) Int. Cl. G10L 15/22

(52) U.S. Cl. CPC G10L 15/22; G10L 2015/225

(57) ABSTRACT

A speech recognition portion generates utterance text representing utterance content by performing a speech recognition process on speech data. A topic analysis portion identifies a word or a phrase of a prescribed topic and a numerical value having a prescribed positional relationship with the word or the phrase from the utterance text. A display processing portion causes a display portion to display display information in which the numerical value or a numerical value derived from the numerical value is shown as a display value in association with the utterance text.

### CROSS-REFERENCE TO RELATED APPLICATION

Priority is claimed on Japanese Patent Application No. 2020-164422, filed Sep. 30, 2020, the content of which is incorporated herein by reference.

### BACKGROUND OF THE INVENTION

### Field of the Invention

The present invention relates to a conversation support device, a conversation support system, a conversation support method, and a storage medium.

### Description of Related Art

Conventionally, a conversation support system for supporting a conversation in which people with normal hearing and hearing-impaired people participate in a conversation held by a plurality of people such as a conference has been proposed. The conversation support system performs a speech recognition process on speech uttered in the conversation, converts the speech into text representing utterance content, and displays the text obtained after the conversion on a screen.

For example, a conference system described in Japanese Unexamined Patent Application, First Publication No. 2019-179480 (hereinafter referred to as Patent Document 1) includes a slave device including a sound collection portion, a text input portion, and a display portion; and a master device connected to the slave device and configured to create minutes using text information obtained in a speech recognition process on speech input from the slave device or text information input from the slave device and share the created minutes with the slave device. In the conference system, when the master device participates in a conversation by text, the master device is controlled such that it makes utterances of other participants have to be waited for and information for making the utterances have to be waited for is transmitted to the slave device.

### SUMMARY OF THE INVENTION

However, understanding by participants may be difficult with only text representing specific utterance content. For example, it is often difficult to understand content related to numerical values such as a degree of progress of business and a time period.

An objective of an aspect according to the present invention is to provide a conversation support device, a conversation support system, a conversation support method, and a storage medium capable of allowing participants of a conversation to understand specific utterance content more easily.

In order to achieve the above-described objective by solving the above-described problems, the present invention adopts the following aspects.

(1) According to an aspect of the present invention, there is provided a conversation support device including: a speech recognition portion configured to generate utterance text representing utterance content by performing a speech recognition process on speech data; a topic analysis portion configured to identify a word or a phrase of a prescribed topic and a numerical value having a prescribed positional relationship with the word or the phrase from the utterance text; and a display processing portion configured to cause a display portion to display display information in which the numerical value or a numerical value derived from the numerical value is shown as a display value in association with the utterance text.

(2) In the above-described aspect (1), the display processing portion may generate display information in which the display value is shown in a format corresponding to the word or the phrase.

(3) In the above-described aspect (1) or (2), the topic analysis portion may extract a unit of a numerical value having a prescribed positional relationship with the word or the phrase and the numerical value associated with the unit from the utterance text.

(4) In the above-described aspect (3), the topic analysis portion may extract a reference quantity and a target quantity from the utterance text using predetermined sentence pattern information indicating a relationship between the reference quantity and the target quantity of an object indicated in the word or the phrase, and the topic analysis portion may determine a ratio of the target quantity to the reference quantity as the display value.

(5) In any one of the above-described aspects (1) to (4), the topic analysis portion may extract a second word or phrase indicating a target object of a period and a date and time including at least one numerical value related to the second word or phrase as a starting point of the period from the utterance text, the period being related to the topic, and the display processing portion may generate the display information indicating a prescribed period that starts from the starting point.

(6) In the above-described aspect (5), when an ending point of the period is not determined, the display processing portion may cause the display portion to display guidance information indicating that the ending point is not determined.

(7) In any one of the above-described aspects (1) to (6), the display processing portion may determine the necessity of an output of the display information on the basis of a necessity indication trend for each word or phrase, the necessity of the display information being indicated in accordance with an operation.

(8) In any one of the above-described aspects (1) to (7), the topic analysis portion may determine the word or the phrase related to the topic conveyed in the utterance text using a topic model indicating a probability of appearance of each word or phrase in each topic.

(9) According to an aspect of the present invention, there is provided a conversation support system including: the conversation support device according to any one of the above-described aspects (1) to (8); and a terminal device, wherein the terminal device includes an operation portion configured to receive an operation, and a communication portion configured to transmit the operation to the conversation support device.

(10) According to an aspect of the present invention, there is provided a computer-readable non-transitory storage medium storing a program for causing a computer to function as the conversation support device according to any one of the above-described aspects (1) to (8).

(11) According to an aspect of the present invention, there is provided a conversation support method for use in a conversation support device, the conversation support method including: a speech recognition process of generating utterance text representing utterance content by performing a speech recognition process on speech data; a topic analysis process of identifying a word or a phrase of a prescribed topic and a numerical value having a prescribed positional relationship with the word or the phrase from the utterance text; and a display processing process of causing a display portion to display display information in which the numerical value or a numerical value derived from the numerical value is shown as a display value in association with the utterance text.

According to the aspect of the present invention, participants of a conversation can be allowed to understand specific utterance content more easily.

According to the above-described aspects (1), (9), (10) or (11), the numerical value related to the prescribed topic included in the utterance text is identified from the utterance text indicating the utterance content and the display value based on the identified numerical value is shown in association with the utterance text. Thus, the user who has access to the display information can intuitively understand the significance of the numerical value uttered in relation to the topic of the utterance content. Consequently, the understanding of the entire utterance content is promoted.

According to the above-described aspect (2), the display value is shown in a format suitable for the topic or the target object indicated in the identified word or phrase. Because the significance of the numerical value, which has been uttered, is emphasized, understanding of the utterance content is promoted.

According to the above-described aspect (3), because the numerical value related to the unit appearing simultaneously with the identified word or phrase in the utterance text is identified, the numerical value related to the topic or the target object related to the word or phrase can be accurately extracted.

According to the above-described aspect (4), the ratio obtained by normalizing the target quantity with respect to the reference quantity of the object related to the identified word or phrase is shown as the display value. Thus, the user can easily understand the significance of a substantial value of the target quantity in relation to the reference quantity.

According to the above-described aspect (5), at least a numerical value for identifying the starting point of the period related to the object that has been uttered is extracted from the utterance text, and the period starting from the starting point indicated by the extracted numerical value is shown. Thus, the user can be allowed to easily understand that the starting point of the period of the target object forms the topic of the utterance content according to the display information.

According to the above-described aspect (6), the user is notified that the ending point of the period in the displayed guidance information is a provisional ending point. It is possible to prompt the user to identify the ending point.

According to the above-described aspect (7), the display information is displayed with respect to the topic or the object related to the word or the phrase whose display of the display information tends to be required and the display information is not displayed with respect to the topic or the object related to the word or the phrase whose display tends to be rejected. Thus, the necessity of the display information is controlled in accordance with preferences of the user regarding the necessity of the display according to the topic or the target object of the utterance content.

According to the above-described aspect (8), the topic analysis portion can determine the word or the phrase related to the topic of the utterance content conveyed in the utterance text in a simple process.

### BRIEF DESCRIPTION OF THE DRAWINGS

FIG. 1 is a block diagram showing an example of a configuration of a conversation support system according to the present embodiment.

FIG. 2 is a block diagram showing an example of a functional configuration of a terminal device according to the present embodiment.

FIG. 3 is an explanatory diagram showing a first generation example of display information.

FIG. 4 is a diagram showing a first display example of a display screen.

FIG. 5 is an explanatory diagram showing a second generation example of display information.

FIG. 6 is a diagram showing a second display example of a display screen.

FIG. 7 is an explanatory showing a second generation example of display information.

FIG. 8 is an explanatory showing a third generation example of display information.

FIG. 9 is a diagram showing a first example of word distribution data of a topic model according to the present embodiment.

FIG. 10 is a diagram showing a second example of word distribution data of a topic model according to the present embodiment.

FIG. 11 is a diagram showing an example of topic distribution data of a topic model according to the present embodiment.

FIG. 12 is a diagram showing a second example of word distribution data of a topic model according to the present embodiment.

FIG. 13 is a flowchart showing an example of a process of displaying utterance text according to the present embodiment.

### DETAILED DESCRIPTION OF THE INVENTION

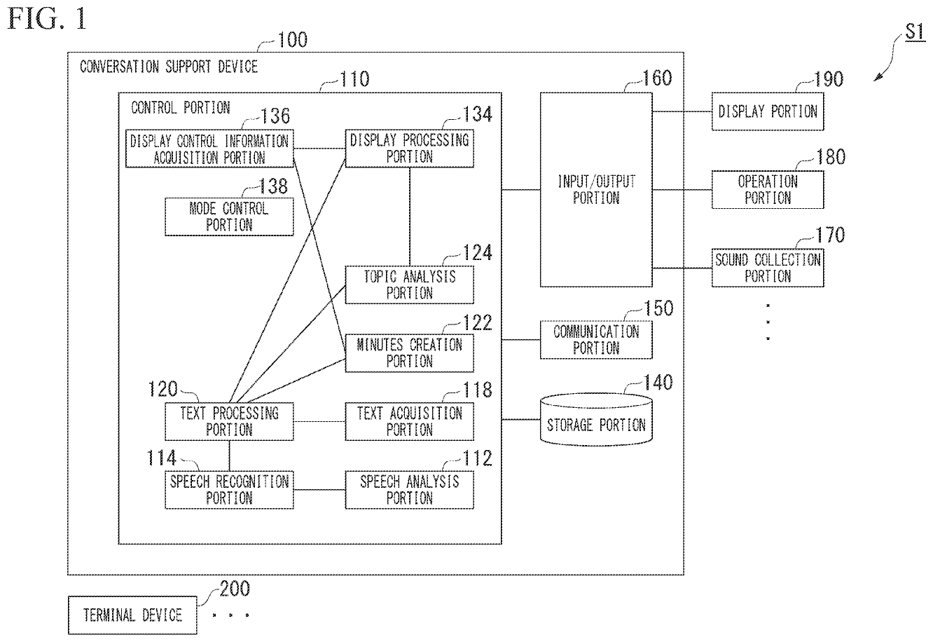

Hereinafter, embodiments of the present invention will be described with reference to the drawings. First, an example of a configuration of a conversation support system S1 according to a present embodiment will be described. FIG. 1 is a block diagram showing the example of the configuration of the conversation support system S1 according to the present embodiment. The conversation support system S1 is configured to include a conversation support device 100 and a terminal device 200.

The conversation support system S1 is used in conversations in which two or more participants participate. The participants may include one or more persons who are disabled in one or both of speaking and listening to speech (hereinafter, “people with disabilities”). A person with a disability may individually operate an operation portion 280 of the terminal device 200 to input text (hereinafter, “second text”) representing utterance content to the conversation support device 100. A person who does not have difficulty in speaking and listening to speech may individually input spoken speech to the conversation support device 100 using a sound collection portion 170 or a device including a sound collection portion (for example, the terminal device 200). The conversation support device 100 performs a known speech recognition process on speech data indicating the input speech and converts utterance content of the speech into text (hereinafter, “first text”) representing the utterance content. The conversation support device 100 causes a display portion 190 to display the text, which has been acquired, each time the text of either the first text obtained in the conversion or the second text obtained from the terminal device 200 is acquired. The people with disabilities can understand the utterance content in a conversation by reading the displayed text (hereinafter, “display text”).

The conversation support device 100 searches for a word or a phrase of a prescribed topic in the acquired utterance text and identifies a numerical value having a prescribed positional relationship with the word or the phrases identified in the search. The conversation support device 100 determines the identified numerical value or a value derived from the identified numerical value as a display value and generates display information for showing the determined display value. The conversation support device 100 causes the display portion 190 and the display portion 290 of the terminal device 200 to display the generated display information in association with the utterance text. The display portions 190 and 290 show the display value related to the utterance text in association with the utterance text having the prescribed topic as the utterance content. Thus, the participant who has access to the display information can easily understand the utterance content related to the numerical value related to the utterance text. In particular, the present embodiment is useful for people with disabilities. This is because the utterance content tends not to be fully understood only with the display text.

For example, when “business progress” is a topic of the utterance content conveyed in the utterance text, the conversation support device 100 generates display information for showing a numerical value indicating a progress rate as a display value in a format (for example, a pie chart) corresponding to the “progress rate” mentioned in the utterance text. The generated display information is displayed on the display portions 190 and 290 in association with the utterance text. Consequently, when a numerical value or a calculated value thereof is shown, the participant can easily understand the utterance content regarding the numerical value and the calculated value. Display examples of display information and the like will be described below.

The conversation support system S1 shown in FIG. 1 includes, but is not limited to, one conversation support device 100 and one terminal device 200. The number of terminal devices 200 may be two or more or may be zero. In the example shown in FIG. 1, the conversation support device 100 and the terminal device 200 have functions as a master device and a slave device, respectively.

In the present application, the term “conversation” means communication between two or more participants and is not limited to communication using speech, and communication using other types of information media such as text is also included. The conversation is not limited to voluntary or arbitrary communication between two or more participants, and may also include communication in a form in which certain participants (for example, moderators) control the utterances of other participants as in conferences, presentations, lectures, and ceremonies. The term “utterance” means communicating intentions using language and includes not only communicating intentions by uttering speech but also communicating intentions using other types of information media such as text.

### (Conversation Support Device)

Next, an example of a configuration of the conversation support device 100 according to the present embodiment will be described. The conversation support device 100 is configured to include a control portion 110, a storage portion 140, a communication portion 150, and an input/output portion 160. The control portion 110 implements a function of the conversation support device 100 and controls the function by performing various types of calculation processes. The control portion 110 may be implemented by a dedicated member, but may include a processor and storage media such as a read only memory (ROM) and a random access memory (RAM). The processor reads a prescribed program pre-stored in the ROM, loads the read program into the RAM, and uses a storage area of the RAM as a work area. The processor implements functions of the control portion 110 by executing processes indicated in various types of commands described in the read program. The functions to be implemented may include a function of each part to be described below. In the following description, executing the process indicated in the instruction described in the program may be referred to as “executing the program,” “execution of the program,” or the like. The processor is, for example, a central processing unit (CPU) or the like.

The control portion 110 is configured to include a speech analysis portion 112, a speech recognition portion 114, a text acquisition portion 118, a text processing portion 120, a minutes creation portion 122, a topic analysis portion 124, a display processing portion 134, a display control information acquisition portion 136, and a mode control portion 138.

Speech data is input from the sound collection portion 170 to the speech analysis portion 112 via the input/output portion 160. The speech analysis portion 112 calculates a speech feature quantity for each frame of a prescribed length with respect to the input speech data. The speech feature quantity is represented by a characteristic parameter indicating an acoustic feature of the speech in the frame. Speech feature quantities, which are calculated, include, for example, power, the number of zero-crossings, mel-frequency cepstrum coefficients (MFCCs), and the like. Among the above speech feature quantities, the power and the number of zero-crossings are used to determine an utterance state. The MFCCs are used for speech recognition. The period of one frame is, for example, 10 ms to 50 ms.

The speech analysis portion 112 determines the utterance state for each frame on the basis of the calculated speech feature quantity. The speech analysis portion 112 performs a known speech section detection process (voice activity detection (VAD) and determines whether or not a processing target frame at that point in time (hereinafter, a “current frame”) is a speech section. The speech analysis portion 112 determines, for example, a frame in which the power is greater than a lower limit of prescribed power and the number of zero-crossings is within a prescribed range (for example, 300 to 1000 times per second) as an utterance section, and determines the other frames as non-speech sections. The speech analysis portion 112 determines that a frame (hereinafter, a “previous frame”) immediately before the current frame is a non-speech section, but determines the utterance state of the current frame as the start of utterance when the current frame is newly determined to be a speech section. A frame in which the utterance state is determined to be the start of utterance is referred to as an “utterance start frame.” The speech analysis portion 112 determines that the previous frame is a speech section, but determines the utterance state of the previous frame as the end of utterance when the current frame is newly determined to be a non-speech section. A frame whose utterance state is determined to be the end of utterance is referred to as an “utterance end frame.” The speech analysis portion 112 determines a series of sections from the utterance start frame to the next utterance end frame as one utterance section. One utterance section roughly corresponds to one utterance. The speech analysis portion 112 sequentially outputs speech feature quantities calculated for each determined utterance section to the speech recognition portion 114. When sound collection identification information is added to the input speech data, the sound collection identification information may be added to the speech feature quantity and output to the speech recognition portion 114. The sound collection identification information is identification information (for example, a microphone identifier (Mic ID) for identifying an individual sound collection portion 170.

The speech recognition portion 114 performs a speech recognition process on the speech feature quantity input from the speech analysis portion 112 for each utterance section using a speech recognition model pre-stored in the storage portion 140. The speech recognition model includes an acoustic model and a language model. The acoustic model is used to determine a phoneme sequence including one or more phonemes from the speech feature quantity. The acoustic model is, for example, a hidden Markov model (HMM). The language model is used to use a word or a phrase including the phoneme sequence. The language model is, for example, n-gram. The speech recognition portion 114 determines a word or a phrase having a highest likelihood calculated using the speech recognition model for the input speech feature quantity as a recognition result. The speech recognition portion 114 outputs first text information indicating text representing a word or a phrase constituting the utterance content as the recognition result to the text processing portion 120. That is, the first text information is information indicating the utterance text (hereinafter, “first text”) representing the utterance content of the collected speech.

When the sound collection identification information is added to the input speech feature quantity, the sound collection identification information may be added to the first text information and output to the text processing portion 120. The speech recognition portion 114 may identify a speaker by performing a known speaker recognition process on the input speech feature quantity. The speech recognition portion 114 may add speaker identification information (a speaker ID) indicating the identified speaker to the speech feature quantity and output the speech feature quantity to which the speaker identification information is added to the text processing portion 120. The speaker ID is identification information for identifying each speaker.

The text acquisition portion 118 receives text information from the terminal device 200 using the communication portion 150. The text acquisition portion 118 outputs the text information, which has been acquired, as the second text information to the text processing portion 120. The second text information is input in response to an operation on the operation portion 280 of the terminal device 200 and indicates text representing utterance content of an input person, mainly for the purpose of communicating with the participants in the conversation. The text acquisition portion 118 may receive text information on the basis of an operation signal input from the operation portion 180 via the input/output portion 160 using a method similar to that of the control portion 210 of the terminal device 200 to be described below. In the present application, the operation signal received from the terminal device 200 and the operation signal input from the operation portion 180 may be collectively referred to as “acquired operation signals” or simply as “operation signals.” The text acquisition portion 118 may add device identification information for identifying a device of either the operation portion 180 or the terminal device 200, which is an acquisition source of the operation signal, to the second text information and output the second text information to which the device identification information is added to the text processing portion 120. “Sound collection identification information,” “speaker identification information,” and “device identification information” may be collectively referred to as “acquisition source identification information.”

The text processing portion 120 acquires each of the first text indicated by the first text information input from the speech recognition portion 114 and the second text indicated by the second text information input from the text acquisition portion 118 as utterance text to be displayed by the display portion 190. The text processing portion 120 performs a prescribed process for displaying or saving the acquired utterance text as display text. For example, the text processing portion 120 performs known morphological analysis on the first text, divides the first text into one or a plurality of words, and identifies a part of speech for each word. The text processing portion 120 may delete text representing a word that does not substantially contribute to the utterance content, such as a word whose identified part of speech is an interjection or a word that is repeatedly spoken within a prescribed period (for example, 10 to 60 seconds), from the first text.

The text processing portion 120 may generate utterance identification information for identifying individual utterances with respect to the first text information input from the speech recognition portion 114 and the second text information input from the text acquisition portion 118 and add the generated utterance identification information to display text information indicating the display text related to the utterance. For example, the text processing portion 120 may generate the order in which the first text information or the second text information is input to the text processing portion 120 as the utterance identification information after the start of a series of conversations. The text processing portion 120 outputs the display text information to the minutes creation portion 122, the topic analysis portion 124, and the display processing portion 134. When acquisition source identification information is added to the first text information input from the speech recognition portion 114 or the second text information input from the text acquisition portion 118, the text processing portion 120 may add the acquisition source identification information to the display text information and output the display text information to which the acquisition source identification information is added to the minutes creation portion 122, the topic analysis portion 124, and the display processing portion 134.

The minutes creation portion 122 sequentially stores the display text information input from the text processing portion 120 in the storage portion 140. In the storage portion 140, the information is formed as minutes information including the stored individual display text information. As described above, the individual display text information indicates the utterance text conveyed in the first text information or the second text information. Accordingly, the minutes information corresponds to an utterance history (an utterance log) in which the utterance text is sequentially accumulated.

The minutes creation portion 122 may store date and time information indicating a date and time when the display text information is input from the text processing portion 120 in the storage portion 140 in association with the display text information. When the acquisition source identification information is added to the display text information, the minutes creation portion 122 may store the acquisition source identification information and the display text information in association with each other in the storage portion 140 in place of the date and time information or together with the date and time information. When the utterance identification information is added to the display text information, the minutes creation portion 122 may store the utterance identification information and the display text information in association with each other in the storage portion 140 in place of the date and time information or the acquisition source identification information, or together with the date and time information or the acquisition source identification information.

The topic analysis portion 124 extracts a word or a phrase (a keyword) related to a prescribed topic from the utterance text indicated in the display text information input from the text processing portion 120. Thereby, the topic of the utterance content conveyed in the utterance text or the keyword representing the topic is analyzed. The word or the phrase means a word or a phrase including a plurality of words and mainly forms an independent word such as a verb, a noun, an adjective, or an adverb. Therefore, the topic analysis portion 124 may perform morphological analysis on the utterance text, determine a word or a phrase, which forms a sentence represented by the utterance text, and a part of speech for each word, and determine an independent word as a processing target section.

The topic analysis portion 124 identifies either a word or a phrase described in a topic model from the utterance text with reference to, for example, the topic model pre-stored in the storage portion 140. The topic model is configured to include information indicating one or more words or phrases related to a topic for each prescribed topic. Some of the above words or phrases may be the same as a topic title (a topic name) Synonym data may be pre-stored in the storage portion 140. The synonym data is data (a synonym dictionary) in which other words or phrases having meanings similar to that of a word or a phrase serving as a headword are associated as synonyms for each word or phrase serving as the headword. The topic analysis portion 124 may identify a synonym corresponding to a word or a phrase that forms a part of the utterance text with reference to the synonym data and identify a word or a phrase that matches the identified synonym from words or phrases described in the topic model.

The topic analysis portion 124 identifies a numerical value that has a prescribed positional relationship with a word or a phrase (including a synonym identified in the above-described method) identified from the utterance text. For example, the topic analysis portion 124 adopts a numerical value, which is behind or in front of the word or the phrase and is within a prescribed number of clauses (for example, two to five clauses) from the word or the phrase as a numerical value having a prescribed positional relationship. The topic analysis portion 124 may extract a unit of a ratio having a prescribed positional relationship with the identified word or phrase (for example, “%,” “percentage,” or the like) and adopt a numerical value adjacent immediately before the extracted unit. In this case, the adopted numerical value is presumed as a numerical value representing the ratio. In accordance with the identified word or phrase, a unit to be extracted may be pre-set. For example, unit information indicating “%” which is a unit of a progress rate as a related word that forms a unit of a quantity related to “progress,” “number” which is a unit of a quantity related to business content, “month,” “day,” “hour,” or “minute” which is a unit of a period of a business item or a starting point or an ending point thereof as a related word that forms a unit of a quantity related to “schedule,” and the like is pre-stored in the storage portion 140. The topic analysis portion 124 can determine unit information corresponding to the identified word or phrase with reference to the unit information.

The topic analysis portion 124 may adopt the identified numerical value as a display value serving as a display target as it is or may adopt another value derived from the identified numerical value as the display value. For example, calculation control information indicating the necessity of a process for deriving a display value in accordance with an identified word or phrase or a relationship with a type of the process may be pre-stored in the storage portion 140. The topic analysis portion 124 can determine the necessity of the process based on the identified word or phrase and the type of the process when the process is necessary with reference to the calculation control information. The process serving as a determination target may correspond to normalization, subtraction, or the like using a prescribed numerical value as a reference value.

The topic analysis portion 124 may cause the storage portion 140 to pre-store the sentence pattern information corresponding to the identified word or phrase. The sentence pattern information is information indicating the identified word or phrase, a reference value of an object indicated in the word or phrase, and a typical sentence pattern provided in a sentence representing a relationship with a target quantity of the object. For example, information indicating a sentence pattern “▴ items among ◯ items” serving as a sentence pattern of a sentence represented by associating a reference value of a degree of progress of business with a target quantity can be adopted as sentence information. In the above, the sentence may include numerical values in which ◯ and ▴ indicate the reference quantity and the target quantity, respectively. The topic analysis portion 124 identifies the sentence pattern information corresponding to the identified word or phrase, collates the sentence pattern indicated in the identified sentence pattern information with the sentence including the identified word or phrase, and extracts the reference quantity and the target quantity from the sentence. The topic analysis portion 124 can calculate the progress rate as a display value by dividing the extracted target quantity by the reference quantity and performing normalization.

The storage portion 140 may include sentence pattern information indicating a typical sentence pattern provided in a sentence in which a period from a starting point to an ending point is represented. When a word or a phrase related to the topic associated with the period is identified, the topic analysis portion 124 may identify sentence pattern information thereof, collate a sentence pattern indicated in the identified sentence pattern information with a sentence including the identified word or phrase, and extract numerical values indicating a starting point in time and an ending point in time from the sentence.

When a topic related to the identified word or phrase is related to a period, the topic analysis portion 124 may extract numerical values indicating one or both of a starting point and an ending point using the above-described unit information without necessarily using the sentence pattern information. When a topic related to the identified word or phrase is related to a period, the topic analysis portion 124 may further extract a second word or phrase indicating a target object (for example, business, a process, or the like) of the period and extract numerical values indicating one or both of a starting point and an ending point using the above-described method with respect to the second word or phrase.

When the topic is set as a period, information indicating a word or a phrase indicating the target object may be set in a topic model. The topic analysis portion 124 can identify a word or a phrase related to a period included in the utterance text and a second word or phrase indicating the target object with reference to the topic model.

However, when a participant of a conversation makes an utterance related to a period, the starting point may be mentioned, but often the ending point may not be mentioned. The topic analysis portion 124 may allow the omission of the ending point or a numerical value indicating the ending point.

The topic analysis portion 124 outputs display value information indicating the extracted numerical value or the derived numerical value as a display value to the display processing portion 134. The topic analysis portion 124 may cause an identified word or phrase, a second word or phrase indicating a target object, or information about the above words or phrases to be included in the display value information.

Because the topic analysis portion 124 determines synonyms using the above-described method with respect to the second word or phrase, the determined synonyms may be used for extraction of various types of numerical values or display to be described below instead of the second word or phrase. When the synonyms have been determined, the topic analysis portion 124 may include information of the determined synonyms in the display value information and output the display value information to the display processing portion 134.

The display processing portion 134 performs a process for displaying the display text indicated in the display text information input from the text processing portion 120. When no display value information has been input from the topic analysis portion, i.e., when a display value related to a topic of the reference text or its object has not been acquired from the utterance text, the display processing portion 134 causes the display portion 190 or 290 to display the display text as it is. Here, the display processing portion 134 reads a display screen template pre-stored in the storage portion 140 and the display processing portion 134 updates a display screen by assigning newly input display text to a preset prescribed text display area for displaying display text within the display screen template. When there is no more area for assigning new display text to the text display area, the display processing portion 134 updates the display screen by scrolling through the display text in the text display area in a prescribed direction (for example, a vertical direction) every time the display text information is newly input from the text processing portion 120. In scrolling, the display processing portion 134 moves a display area of the already displayed display text already assigned to the text display area in a prescribed direction, and secures an empty area to which no display text is assigned. The empty area is provided in contact with one end of the text display area in a direction opposite to a movement direction of the display text within the text display area. The display processing portion 134 determines an amount of movement of the already displayed display text so that a size of the empty area, which is secured, is equal to a size of the display area required for displaying new display text. The display processing portion 134 assigns new display text to the secured empty area and deletes the already displayed display text arranged outside of the text display area according to movement.

On the other hand, when the display value related to the topic of the utterance text has been acquired, the display processing portion 134 further causes the display portion 190 or 290 to display the display information showing the display value in association with the display text. In this case, the display value information is input from the topic analysis portion 124 to the display processing portion 134. The display processing portion 134 generates, for example, a display value image showing a display value of a pie chart, a bar graph, or the like as an example of display information within the same display frame as the display text. Display format information indicating a display value image format (a display format) may be stored and the display format corresponding to a word or a phrase extracted from the utterance text may be selected with reference to the display format information. The display processing portion 134 generates a display value image showing the display value in the selected display format. For example, a pie chart is associated with a word or a phrase related to progress and a bar graph is associated with a word or a phrase related to a period as a graphic indicating the period. When the word or the phrase extracted from the utterance text is related to the period, the display processing portion 134 displays the graphic showing the period and an image of a calendar having a display field of a day, a week, or a month including the period may be generated as the display value image.

When a starting point is determined and an ending point is not determined in a period serving as a display target, the display processing portion 134 may determine a period in which a point in time after an elapse of a prescribed period from the starting point is set as the ending point as a display period which is the period of the display target. The prescribed period may be pre-stored in the storage portion 140 as period information in association with a second phrase indicating the target object of the period. The display processing portion 134 can identify the period corresponding to the second word or phrase indicated in the display value information with reference to the period information. When the second word or phrase and the period are determined in the display value information, the display processing portion 134 may update the period corresponding to the second word or phrase included in the period information using the period indicated in the display value information. The display processing portion 134 may determine the period using any one of the latest period, a simple average value, a weighted average value, and a most frequent value indicated in the display value information. When the weighted average value is calculated, a larger value may be used for a weighting coefficient for a new period with a shorter period up to the present point in time.

When the starting point is determined and the ending point is not determined, the display processing portion 134 may further include guidance information indicating that the ending point is not determined in the display screen in association with the display information. For example, the display processing portion 134 arranges the guidance information in the same display frame as the display information or in an area adjacent to the display frame.

When text deletion information is input from the display control information acquisition portion 136 while the display screen is displayed, the display processing portion 134 may identify a section of a part of the display text assigned to the text display area and delete the display text within the identified section. The text deletion information is control information that indicates the deletion of the display text and the section of the display text serving as a target thereof. A target section may be identified using utterance identification information included in the text deletion information. The display processing portion 134 updates the display screen by moving newer other display text to an area where display text is deleted within the text display area (text filling).

The display processing portion 134 outputs display screen data representing the updated display screen to the display portion 190 via the input/output portion 160 each time the display screen is updated. The display processing portion 134 may transmit the display screen data to the terminal device 200 using the communication portion 150. Consequently, the display processing portion 134 can cause the display portion 190 of its own device and the display portion 290 of the terminal device 200 to display the updated display screen. The display screen displayed on the display portion 190 of the own device may include an operation area. Various types of screen components for operating the own device and displaying an operating state are arranged in the operation area.

The display control information acquisition portion 136 receives display control information for controlling the display of the display screen from the terminal device 200. The display control information acquisition portion 136 may generate a display control signal on the basis of an operation signal input via the input/output portion 160 using a method (to be described below) similar to that of the control portion 210 of the terminal device 200. The display control information acquisition portion 136 outputs the acquired display control information to the display processing portion 134. The extracted display control signal may include the above-described text deletion information.

The mode control portion 138 controls an operation mode of the conversation support device 100 on the basis of the acquired operation signal. The mode control portion 138 enables the necessity or combination of functions capable of being provided by the conversation support device 100 to be set as the operation mode. The mode control portion 138 extracts mode setting information related to the mode setting from the acquired operation signal and outputs mode control information for issuing an instruction for the operation mode indicated in the extracted mode setting information to each part.

The mode control portion 138 can control, for example, the start of an operation, the end of the operation, the necessity of creation of minutes, the necessity of recording, and the like. When the extracted mode setting information indicates the start of the operation, the mode control portion 138 outputs the mode control information indicating the start of the operation to each part of the control portion 110. Each part of the control portion 110 starts a prescribed process in the own part when the mode control information indicating the start of the operation is input from the mode control portion 138. When the extracted mode setting information indicates the end of the operation, the mode control portion 138 outputs the mode control information indicating the end of the operation to each part of the control portion 110. Each part of the control portion 110 ends a prescribed process in the own part when the mode control information indicating the end of the operation is input from the mode control portion 138. When the extracted mode setting information indicates the creation of minutes, the mode control portion 138 outputs the mode control information indicating the creation of minutes to the minutes creation portion 122. When the extracted mode setting information indicates the creation of minutes, the mode control portion 138 outputs the mode control information indicating the creation of minutes to the minutes creation portion 122. When mode control information indicating the necessary creation of minutes is input from the mode control portion 138, the minutes creation portion 122 starts the storage of the display text information input from the text processing portion 120 in the storage portion 140. Consequently, the creation of minutes is started. When the extracted mode setting information indicates the unnecessary creation of minutes, the mode control portion 138 outputs the mode control information indicating the unnecessary creation of minutes to the minutes creation portion 122. When the mode control information indicating the unnecessary creation of minutes is input from the mode control portion 138, the minutes creation portion 122 stops the storage of the display text information input from the text processing portion 120 in the storage portion 140. Consequently, the creation of minutes is stopped.

The storage portion 140 stores various types of data for use in a process in the control portion 110 and various types of data acquired by the control portion 110. The storage portion 140 is configured to include, for example, the above-mentioned storage media such as a ROM and a RAM.

The communication portion 150 connects to a network wirelessly or by wire using a prescribed communication scheme and enables transmission and reception of various types of data to and from other devices. The communication portion 150 is configured to include, for example, a communication interface. The prescribed communication scheme may be a scheme defined by any standard among IEEE 802.11, the 4^{th} generation mobile communication system (4G), the 5^{th} generation mobile communication system (5G), and the like.

The input/output portion 160 can input and output various types of data wirelessly or by wire from and to other members or devices using a prescribed input/output scheme. The prescribed input/output scheme may be, for example, a scheme defined by any standard among a universal serial bus (USB), IEEE 1394, and the like. The input/output portion 160 is configured to include, for example, an input/output interface.

The sound collection portion 170 collects speech arriving at the own portion and outputs speech data indicating the collected speech to the control portion 110 via the input/output portion 160. The sound collection portion 170 includes a microphone. The number of sound collection portions 170 is not limited to one and may be two or more. The sound collection portion 170 may be, for example, a portable wireless microphone. The wireless microphone mainly collects speech uttered by an individual owner.

The operation portion 180 receives an operation by the user and outputs an operation signal based on the received operation to the control portion 110 via the input/output portion 160. The operation portion 180 may include a general-purpose input device such as a touch sensor, a mouse, or a keyboard or may include a dedicated member such as a button, a knob, or a dial.

The display portion 190 displays display information based on display data such as display screen data input from the control portion 110, for example, various types of display screens. The display portion 190 may be, for example, any type of display among a liquid crystal display (LCD), an organic electro-luminescence display (OLED), and the like. A display area of a display forming the display portion 190 may be configured as a single touch panel in which detection areas of touch sensors forming the operation portion 180 are superimposed and integrated.

### (Terminal Device)

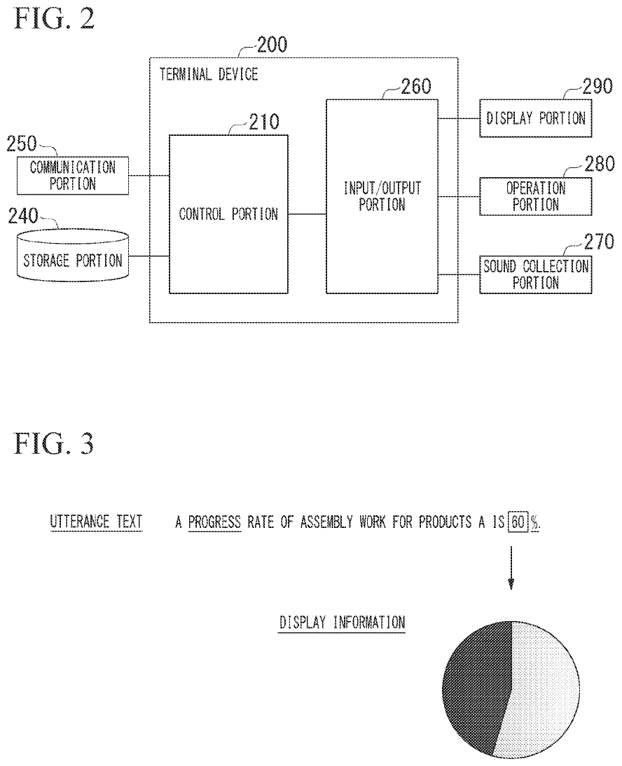

Next, an example of a configuration of the terminal device 200 according to the present embodiment will be described. FIG. 2 is a block diagram showing an example of a functional configuration of the terminal device 200 according to the present embodiment.

The terminal device 200 is configured to include a control portion 210, a storage portion 240, a communication portion 250, an input/output portion 260, a sound collection portion 270, an operation portion 280, and a display portion 290.

The control portion 210 implements a function of the terminal device 200 and controls the function by performing various types of calculation processes. The control portion 210 may be implemented by a dedicated member, but may include a processor and a storage medium such as a ROM or a RAM. The processor reads a prescribed control program pre-stored in the ROM, loads the read program into the RAM, and uses a storage area of the RAM as a work area. The processor implements functions of the control portion 210 by executing processes indicated in various types of commands described in the read program.

The control portion 210 receives display screen data from the conversation support device 100 using the communication portion 250 and outputs the received display screen data to the display portion 290. The display portion 290 displays a display screen based on the display screen data input from the control portion 210. The control portion 210 receives an operation signal indicating a character from the operation portion 280 while the display screen is displayed and uses the communication portion 250 for the conversation support device 100 to transmit text information indicating text including one or more characters that have been received (a text input). The text received at this stage corresponds to the above-described second text.

The control portion 210 identifies a partial section indicated in an operation signal input from the operation portion 280 within display text assigned in a text display area of the display screen and generates text deletion information indicating the deletion of the display text using the identified section as a target when a deletion instruction is issued by an operation signal (text deletion). The control portion 210 transmits the text deletion information generated using the communication portion 250 to the conversation support device 100.

The storage portion 240 stores various types of data for use in a process of the control portion 210 and various types of data acquired by the control portion 210. The storage portion 240 is configured to include storage media such as a ROM and a RAM.

The communication portion 250 connects to a network wirelessly or by wire using a prescribed communication scheme, and enables transmission and reception of various types of data to and from other devices. The communication portion 250 is configured to include, for example, a communication interface.

The input/output portion 260 can input and output various types of data from and to other members or devices using a prescribed input/output scheme. The input/output portion 260 is configured to include, for example, an input/output interface.

The sound collection portion 270 collects speech arriving at the own portion and outputs speech data indicating the collected speech to the control portion 210 via the input/output portion 260. The sound collection portion 270 includes a microphone. The speech data acquired by the sound collection portion 270 may be transmitted to the conversation support device 100 via the communication portion 250 and a speech recognition process may be performed in the conversation support device.

The operation portion 280 receives an operation by the user and outputs an operation signal based on the received operation to the control portion 210 via the input/output portion 260. The operation portion 280 includes an input device.

The display portion 290 displays display information based on display data such as display screen data input from the control portion 210. The display portion 290 includes a display. The display forming the display portion 290 may be integrated with a touch sensor forming the operation portion 280 and configured as a single touch panel.

### (Operation Example)

Next, an example of an operation of the conversation support system S1 according to the present embodiment will be described. FIG. 3 is an explanatory diagram showing a first generation example of display information. In the example shown in FIG. 3, it is assumed that the latest utterance text “A progress rate of assembly work for products A is 60%.” acquired at that point in time is a processing target. In this case, the topic analysis portion 124 of the conversation support device 100 identifies a phrase “progress rate,” which is related to a topic “work progress” from the utterance text, from the utterance text with reference to a topic model. In FIG. 3, a word or a phrase used as a keyword within the utterance text is underlined. The topic analysis portion 124 further identifies the unit “%” of a ratio having a prescribed positional relationship with the phrase “progress rate” identified from the utterance text. The topic analysis portion 124 extracts a numerical value “60” placed immediately before the identified unit “%” as the numerical value associated with the identified unit “%.” The topic analysis portion 124 generates display value information indicating the identified phrase “progress rate” and the numerical value “60” and outputs the generated display value information to the display processing portion 134.

The display processing portion 134 identifies a pie chart as a display format corresponding to the phrase “progress rate” indicated in the display value information input from the topic analysis portion 124 with reference to the display format information. The display processing portion 134 generates the pie chart showing the numerical value 60% indicated in the display value information as the display information.

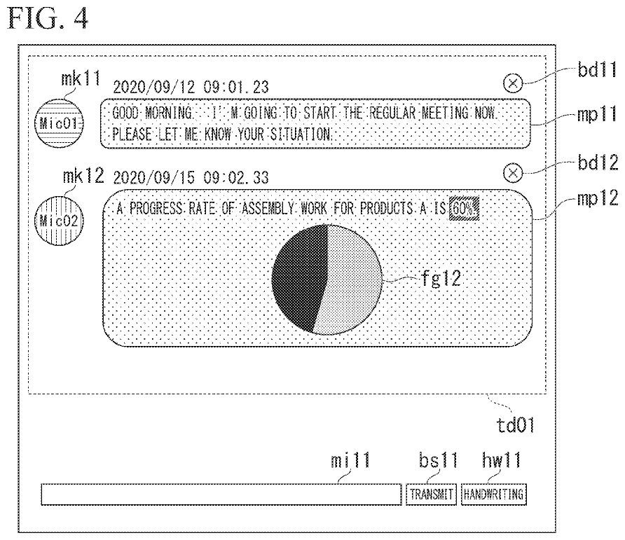

FIG. 4 is a diagram showing a first display example of the display screen. This display screen may be displayed on one or both of the display portion 190 of the conversation support device 100 and the display portion 290 of the terminal device 200. Hereinafter, an operation on the terminal device 200 and display content of the terminal device 200 will be described using a case in which content is displayed on the display portion 290 as an example. On the display screen shown in the example of FIG. 4, the display text for each utterance is displayed within a display frame (a speech balloon). With respect to display text from which a numerical value related to an identified word or phrase is extracted, display information showing the numerical value is displayed within a display frame surrounding the display text. In a display frame mp12, the utterance text shown in the example of FIG. 3 is arranged as the display text and display information fg12 is further arranged.

A text display area td01, a text input field mill, a transmit button bs11, and a handwriting button hw11 are arranged on the display screen. The text display area td01 occupies most of the area of the display screen (for example, half of an area ratio or more). In the text display area td01, a set of an acquisition source identification mark and a display frame is arranged for an individual utterance. When the display screen is updated, the display processing portion 134 of the conversation support device 100 arranges a display frame in which the acquisition source identification mark corresponding to the acquisition source identification information added to the display text information and the display text indicated in the display text information are arranged on each line within the text display area every time the display text information is acquired. The display processing portion 134 arranges date and time information at the upper left end of an individual display frame and a delete button at the upper right end. When new display text information is acquired after the text display area td01 is filled with the set of the acquisition source identification mark and the display frame, the display processing portion 134 moves the set of the acquisition source identification mark and the display frame that have already been arranged in a prescribed direction (for example, an upward direction) and disposes a set of a display frame in which the new display text is arranged and an acquisition source identification mark related to the display text in an empty area generated at an end (for example, downward) in the movement direction of the text display area td01 (scroll). The display processing portion 134 deletes the set of the acquisition source identification mark and the display frame that move outside of the text display area td01.

The acquisition source identification mark is a mark indicating the acquisition source of an individual utterance. In the example shown in FIG. 4, sound collection portion marks mk11 and mk12 correspond to acquisition source identification marks indicating microphones Mic01 and Mic02 as the acquisition sources, respectively. The display processing portion 134 extracts the acquisition source identification information from each piece of the first text information and the second text information input to the own portion and identifies the acquisition source indicated in the extracted acquisition source identification information. The display processing portion 134 generates an acquisition source identification mark including text indicating the identified acquisition source. The display processing portion 134 may cause a symbol or a figure for identifying an individual acquisition source to be included in the acquisition source identification mark together with or in place of the text. The display processing portion 134 may set a form which differs in accordance with the acquisition source for the acquisition source identification mark and display the acquisition source identification mark in the set form. A form of the acquisition source identification mark may be, for example, any one of a background color, a density, a display pattern (highlight, shading, or the like), a shape, and the like.

Display frames mp11 and mp12 are frames in which display text indicating individual utterances is arranged. Date and time information and a delete button are arranged at the upper left end and the upper right end of an individual display frame, respectively. The date and time information indicates a date and time when the display text arranged within the display frame has been acquired. The delete buttons bd11 and bd12 are buttons for issuing an instruction for deleting the display frames mp11 and mp12 and the acquisition source identification information, which are arranged in association with each other, by pressing the delete buttons bd11 and bd12. In the present application, the term “pressing” means that a screen component such as a button is indicated, that a position within the display area of the screen component is indicated, or that an operation signal indicating the position is acquired. For example, when the pressing of the delete button bd11 is detected, the display processing portion 134 deletes the sound collection portion mark mk11 and the display frame mp11 and deletes the date and time information “2020/09/12 09:01.23” and the delete button bd11. The control portion 210 of the terminal device 200 identifies a delete button that includes the position indicated in the operation signal received from the operation portion 280 within the display area, generates text deletion information indicating the deletion of a display frame including display text and an acquisition source mark corresponding to the delete button, and transmits the text deletion information to the display control information acquisition portion 136 of the conversation support device 100. The display control information acquisition portion 136 outputs the text deletion information received from the terminal device 200 to the display processing portion 134. The display processing portion 134 updates the display screen by deleting the display frame and the acquisition source mark indicated in the text deletion information from the display control information acquisition portion 136 and deleting the date and time information and the delete button attached to the display frame.

The display frame mp12 includes the display text and the display information fg12, which are arranged in that order. Thereby, it is clearly shown that the display information fg12 has a relationship with the display text. The display text and the display information fg12 correspond to the display text and the display information shown in the example of FIG. 3. A highlighted part of the display text indicates the numerical value “60” to be shown as display information and the phrase “progress rate” related to a prescribed topic having a prescribed positional relationship with the numerical value. The user who visually recognizes the display screen can easily ascertain the information “progress rate is 60%” as utterance content in which the numerical value indicated as the display information fg12 is “60” and the numerical value has been uttered according to utterance text.

When the display processing portion 134 detects that the display information fg12 is pressed, the display information fg12 may be deleted from the display screen. When the display information fg12 is not displayed, the display processing portion 134 may cause the display information fg12 to be included and displayed in the display frame mp12 if pressing of a highlighted part of the display text is detected in a situation in which the display information fg12 is not displayed.

When the display processing portion 134 detects that the delete button bd12 is pressed, the display information fg12 being displayed as well as the sound collection portion mark mk12, the acquisition date and time, the display frame mp12, and the display text may be deleted.

A text input field mill is a field for receiving an input of text. The control portion 210 of the terminal device 200 identifies characters indicated in the operation signal input from the operation portion 280 and sequentially arranges the identified characters in the text input field mill. The number of characters capable of being received at one time is limited within a range of a size of the text input field mill. The number of characters may be predetermined on the basis of a range such as the typical number of characters and the number of words that forms one utterance (for example, within 30 to 100 full-width Japanese characters).

A transmit button bs11 is a button for issuing an instruction for transmitting text including characters arranged in the text input field mill when pressed. When the transmit button bs11 is indicated in the operation signal input from the operation portion 280, the control portion 210 of the terminal device 200 transmits text information indicating the text arranged in the text input field mill to the text acquisition portion 118 of the conversation support device 100 at that point in time.

A handwriting button hw11 is a button for issuing an instruction for a handwriting input by pressing. When the handwriting button hw11 is indicated in the operation signal input from the operation portion 280, the control portion 210 of the terminal device 200 reads handwriting input screen data pre-stored in the storage portion 240 and outputs the handwriting input screen data to the display portion 290. The display portion 290 displays a handwriting input screen (not shown) on the basis of the handwriting input screen data input from the control portion 210. The control portion 210 sequentially identifies positions within the handwriting input screen by an operation signal input from the operation portion 280, and transmits handwriting input information indicating a curve including a trajectory of the identified positions to the conversation support device 100. When the handwriting input information is received from the terminal device 200, the display processing portion 134 of the conversation support device 100 sets the handwriting display area at a prescribed position within the display screen. The handwriting display area may be within the range of the text display area or may be outside of the range. The display processing portion 134 updates the display screen by arranging the curve indicated in the handwriting input information within the set handwriting display area.

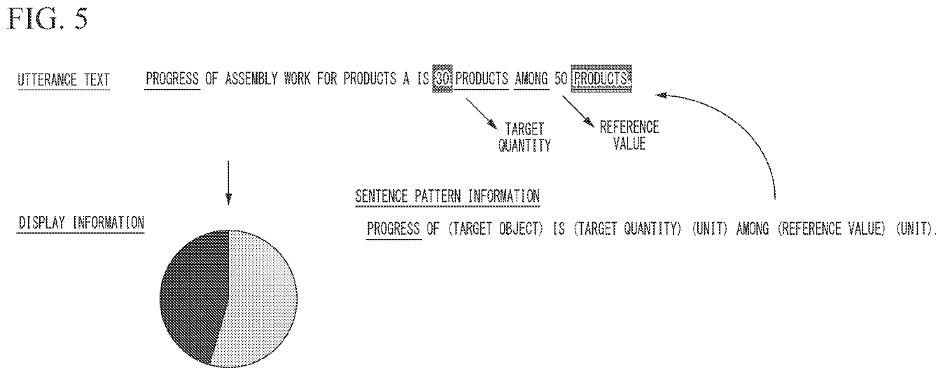

FIG. 5 is an explanatory diagram showing a second generation example of display information. In the example shown in FIG. 5, it is assumed that the latest utterance text “Progress of assembly work for products A is 30 products among 50 products.” acquired at that point in time is a processing target. The topic analysis portion 124 of the conversation support device 100 identifies the word “progress,” which is related to the topic “business progress” from the utterance text, from the utterance text with reference to the topic model. The topic analysis portion 124 selects information indicating a sentence pattern “Progress of (target object) is (target quantity) (unit) among (reference value) (unit).” as sentence pattern information corresponding to “progress.” There is shown a condition in which a word or a phrase having an attribute is included within the utterance text serving as an analysis target with respect to an attribute “reference value” shown within parentheses. Accordingly, the selected sentence pattern information indicates a sentence pattern used in a sentence indicating that the reference value is set as a reference or a target and the progress of the target object has reached a degree mentioned in the target quantity. It is shown that the reference value and the target quantity are numerical values placed in front of units. The word “among” is placed in front of the reference value and behind the target quantity, so that the ratio of the target quantity to the reference value indicates the progress rate in combination with the word “progress.”

Therefore, the topic analysis portion 124 refers to the sentence pattern information, identifies the word “among” placed behind “progress” from the utterance text, identifies a numerical value “50” placed behind the word “among” and placed in front of the word “products” as the reference quantity, and identifies a numerical value “30” placed in front of the word “products” which is in front of the word “among” as the target quantity. The topic analysis portion 124 divides the identified target quantity “30” by the reference quantity “50” to calculate a numerical value “60%” indicating the progress rate. The topic analysis portion 124 generates display value information indicating the identified words “progress” and “among,” the reference value “50,” the target value “30,” or the numerical value “60” and outputs the generated display value information to the display processing portion 134.

The display processing portion 134 identifies a pie chart as a display format corresponding to the words “progress” and “among” indicated in the display value information input from the topic analysis portion 124 with reference to the display format information. The display processing portion 134 generates a pie chart showing the numerical value 60% indicated in the display value information as the display information.

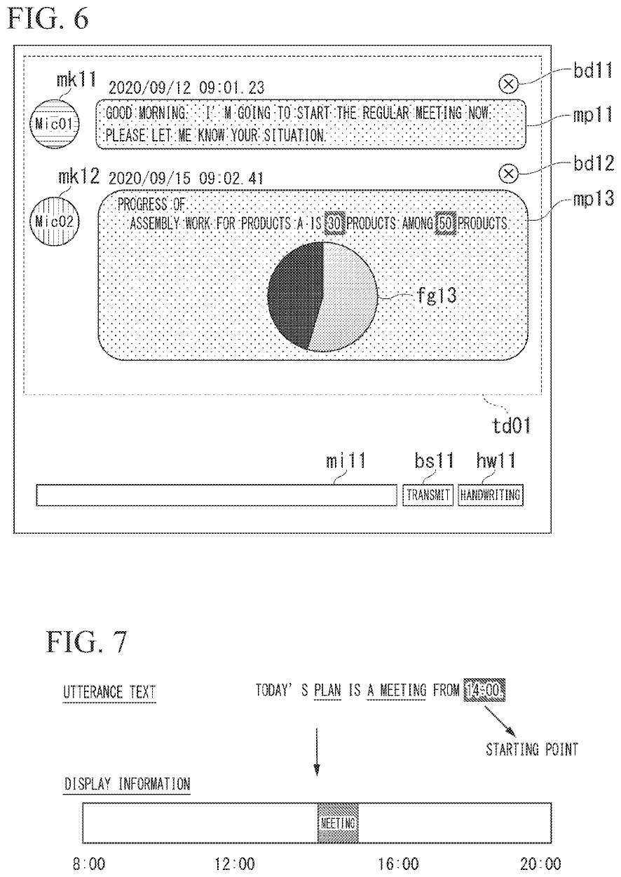

FIG. 6 is a diagram showing a second display example of a display screen. In a display frame mp13 of the display screen shown in the example of FIG. 6, unlike the example shown in FIG. 4, the display text shown in the example of FIG. 5 and the pie chart serving as display information fg13 are displayed. In the display text, the reference value “50” and the target value “30” are displayed as highlighted parts, respectively. The display processing portion 134 can identify the reference value and the target value from the display text with reference to the display value information, and can make the setting so that parts of the reference value and the target value, which have been identified, are highlighted as the display form. Thus, the user who has access to the display screen can intuitively ascertain the reference value of “50 products,” the target value of “30 products,” and the progress rate of “60%” in the pie chart displayed as the display information fg13.

FIG. 7 is an explanatory diagram showing a second generation example of display information. In the example shown in FIG. 7, it is assumed that the latest utterance text “Today's plan is a meeting from 14:00.” acquired at that point in time is a processing target.

The topic analysis portion 124 of the conversation support device 100 identifies the word “plan” related to the topic “schedule” from the utterance text with reference to the topic model and identifies a word “meeting” which is an independent word placed behind the word “plan” within a prescribed range as a second word indicating the target object of the period. The topic analysis portion 124 can further identify the word “from” indicating the starting point placed behind the identified second word “meeting” within a prescribed range and identify a starting point in time “14:00” serving as the starting point of the period as a combination of a unit placed behind the word “from” and a numerical value associated with the unit. The topic analysis portion 124 outputs the identified words “plan” and “meeting” and display value information indicating the numerical value “14:00” indicating the starting point as a display value to the display processing portion 134.

The topic analysis portion 124 may identify sentence pattern information representing a period from a starting point to an ending point as the sentence pattern information corresponding to the identified word “plan” among various types of sentence pattern information stored in the storage portion 140. The topic analysis portion 124 may try to extract a numerical value indicating a point in time serving as the starting point and a numerical value indicating a point in time serving as the ending point from the utterance text using the identified sentence pattern information.

The display processing portion 134 identifies a bar graph as a display format corresponding to the word “plan” indicated in the display format information input from the topic analysis portion 124 with reference to display format information. The display processing portion 134 generates a period starting from the starting point “14:00” indicated in the display value information as the display information indicated in the bar graph.

The topic analysis portion 124 may identify the word “today” as a word indicating a range of the period placed in front of the word “plan” within a predetermined range from the word “plan” within the utterance text, and may include the identified word in the display value information.

The display processing portion 134 may determine a prescribed long period (from 08:00 to 20:00 in the example of FIG. 7) in a day to which a point in time belongs as a range capable of being displayed from the range “today” indicated in the display value information.

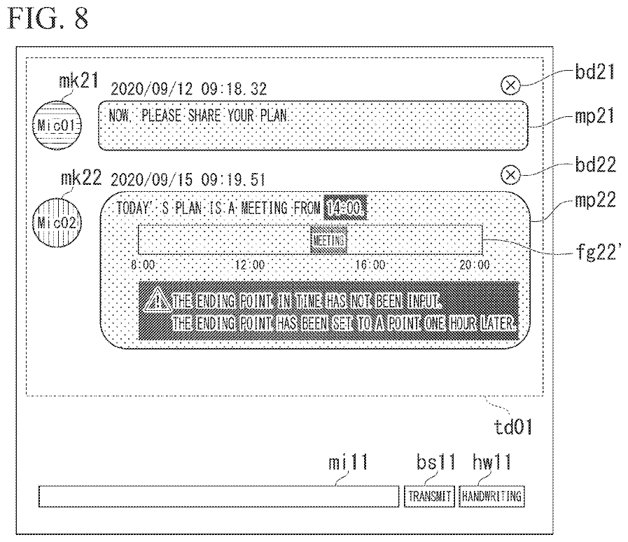

FIG. 8 is an explanatory diagram showing a third generation example of display information. In a display frame mp22 of the display screen illustrated in FIG. 8, the display text shown in the example of FIG. 7 and the bar graph are displayed as display information fg22. Within the display text, a part of the numerical value “14” indicating the starting point is displayed as a highlighted part. The display processing portion 134 can identify the above numerical value from the display text with reference to the display value information and set the highlight as a display form for the part of the identified numerical value. Thus, the user who has access to the display screen can intuitively ascertain that “14:00” as the starting point in time in the bar graph displayed as the display information fg22. However, in the example shown in FIG. 7, the display processing portion 134 determines 15:00 after the elapse of a prescribed time period (one hour) from the starting point in time serving as the ending point. This is because a point in time serving as the ending point has not been identified from the display text.

The display frame mp22 including guidance information following the display information fg22 is displayed. The guidance information includes a message “The ending point in time has not been input.” indicating that the ending point has not been set, and a message “The ending point has been set to a point one hour after the start.” indicating that the display processing portion 134 has set a point one hour after the starting point as the ending point. The guidance information includes a symbol with an exclamation mark “!” enclosed in a triangle at the head thereof in the above messages. Thereby, the user who has access to the display screen is allowed to notice that the ending point in time has not been input and that a point one hour after the start time has been set as the ending point in time.

Here, the display processing portion 134 may change a position of the ending point shown in the display information fg22 (a position at the right end of the bar graph in the example shown in FIG. 8) on the basis of an operation signal and determine the ending point in time serving as the ending point corresponding to the changed position. When the ending point in time has been determined on the basis of the operation signal, the display processing portion 134 may delete the guidance information.

Likewise, the display processing portion 134 may change a position of the starting point indicated in the display information fg22 on the basis of the operation signal and determine the starting point in time serving as the starting point corresponding to the changed position.

In the display format information, the calendar may be associated with “plan” as the display format. In this case, the display processing portion 134 selects the calendar as the display format corresponding to “plan” indicated in the display value information. The calendar has a display field for a date for each month. The display processing portion 134 may configure a calendar showing the above-described period in the display field of the date at that point in time within a month to which the date at that point in time belongs as display information.

### (Topic Model)

Next, the topic model according to the present embodiment will be described. The topic model is data indicating a probability of appearance of each of a plurality of words or phrases representing an individual topic. In other words, a topic is characterized by a probability distribution (a word distribution) between a plurality of typical words or phrases. A method of expressing an individual topic with a probability distribution between a plurality of words or phrases is referred to as a bag of words (BoW) expression. In the BoW expression, the word order of a plurality of words constituting a sentence is ignored. This is based on the assumption that the topic does not change as the word order changes.

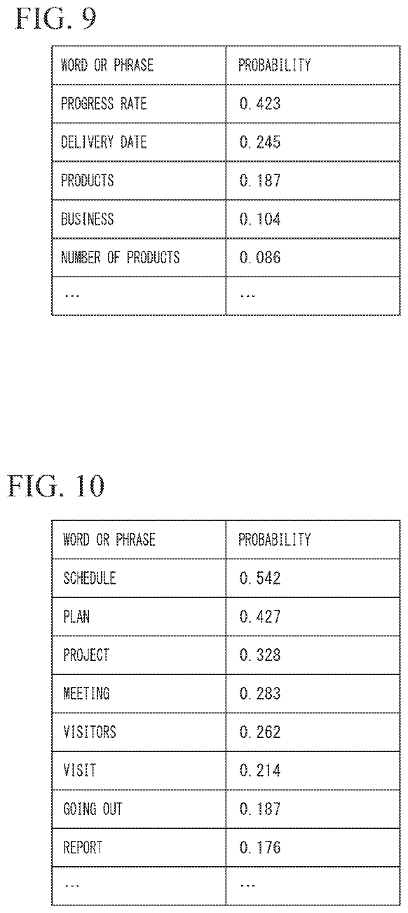

FIGS. 9 and 10 are diagrams showing an example of word distribution data of the topic model according to the present embodiment. FIG. 9 shows an example of a part whose topic is “business progress.” In the example shown in FIG. 9, words or phrases related to the topic “business progress” include “progress rate,” “delivery date,” “products,” “business,” and “number of products.” In the example shown in FIG. 10, “schedule,” “plan,” “project,” “meeting,” “visitors,” “visit,” “going out,” and “report” are used as the word or the phrase related to the topic “business progress.” In FIGS. 9 and 10, the probability of appearance when the topic is included in the utterance content is shown in association with an individual word or phrase. In the present embodiment, as a word or a phrase related to an individual topic, an independent word related to a word or a phrase whose appearance probability is greater than a threshold value of the appearance probability of a prescribed word or phrase when the topic is conveyed is adopted. In the present embodiment, the appearance probability may be omitted without being necessarily included and stored in the topic model.

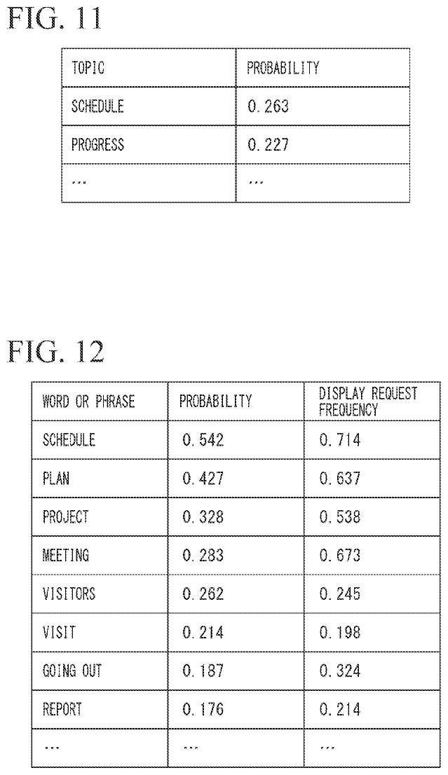

FIG. 11 is a diagram showing an example of topic distribution data of the topic model according to the present embodiment. The topic distribution data is data indicating an appearance probability of an individual topic appearing in the entire document of an analysis target. The topic model includes topic distribution data generally, but the topic distribution data may be omitted without being stored in the storage portion 140 in the present embodiment. In the example shown in FIG. 11, the appearance probability for each topic obtained by analyzing an utterance history forming minutes information is shown. In the topic distribution data shown in FIG. 11, “schedule” and “progress” are included as individual topics, and the topics are arranged in descending order of appearance probability. In the present embodiment, a topic whose appearance probability is greater than the threshold value of the appearance probability of a prescribed topic is adopted and other topics may not be used. Thereby, reference information related to the reference text for topics that are frequently on the agenda is provided and the provision of reference information for other topics is limited.

The conversation support device 100 may include a topic model update portion (not shown) for updating the topic model in the control portion 110. The topic model update portion performs a topic model update process (learning) using the utterance history stored in the storage portion 140 as training data (also called teacher data). Here, it is assumed that the utterance history has a plurality of documents and an individual document has one or more topics. In the present embodiment, each of the individual documents may be associated with one meeting. As described above, each utterance may include only one sentence or may include a plurality of sentences. A single utterance may have one topic or a plurality of utterances may have one common topic.

In a topic model update process, a topic distribution θₘ is defined for each document m. The topic distribution θₘ is a probability distribution having a probability θₘₗ that a document m will have a topic l as an element for each topic l. However, a probability θₘₗ is a real number of 0 or more and 1 or less and a sum of probabilities θₘₗ of topics l is normalized to be 1. As described above, in the topic model, a word distribution ϕₗ is defined for each topic l. A word distribution ϕₗ is a probability distribution having an appearance probability ϕₗₖ of a word k in the topic l as an element. The appearance probability ϕₗₖ is a real number of 0 or more and 1 or less and a sum of probabilities ϕₗₖ of words K is normalized to be 1.

The topic model update portion can use, for example, a latent Dirichlet allocation (LDA) method, in the topic model update process. The LDA method is based on the assumption that the word and topic distributions each follow a multinomial distribution and their prior distributions follow a Dirichlet distribution. The multinomial distribution shows a probability distribution of probabilities obtained by executing an operation of extracting one word or phrase from K kinds of words or phrases N times when the appearance probability of a word or a phrase k is ϕₖ. The Dirichlet distribution shows a probability distribution of parameters of the multinomial distribution under the constraint that the appearance probability ϕₖ of the word or the phrase k is 0 or more and a sum of probabilities of K types of words or phrases is 1. Therefore, the topic model update portion calculates a word or phrase distribution and its prior distribution for each topic with respect to the entire document of an analysis target and calculates a topic distribution indicating the appearance probability of an individual topic and its prior distribution.

Unknown variables of a topic model are a set of topics including a plurality of topics, a topic distribution including an appearance probability for each topic of the entire document, and a phrase distribution group including a phrase distribution for each topic. According to the LDA method, the above unknown variables can be determined on the basis of a parameter group (also referred to as a hyperparameter) that characterizes each of the multinomial distribution and the Dirichlet distribution described above. The topic model update portion can recursively calculate a set of parameters that maximizes a logarithmic marginal likelihood given in the above unknown variables, for example, using the variational Bayesian method. A marginal likelihood corresponds to a probability density function when the prior distribution and the entire document of an analysis target are given. Here, maximization is not limited to finding a maximum value of the logarithmic marginal likelihood, but means performing a process of calculating or searching for a parameter group that increases the logarithmic marginal likelihood. Thus, the logarithmic marginal likelihood may temporarily decrease in the maximization process. In the calculation of the parameter group, a constraint condition that a sum of appearance probabilities of words or phrases becomes 1 with respect to appearance probabilities forming the individual word or phrase distributions is imposed. The topic model update portion can determine a topic set, a topic distribution, and a word or phrase distribution group as a topic model using the calculated parameter group.

By updating the topic model using the utterance history, the topic model update portion reflects a topic that frequently appears as the utterance content in the utterance history or a word or a phrase that frequently appears when the topic is the utterance content in the topic model.

The topic model update portion may use a method such as a latent semantic indexing (LSI) method instead of the LDA method in the topic model update process.

Instead of providing the topic model update portion, the control portion 110 may transmit the utterance history of its own device to another device and request the generation or update of the topic model. The control portion 110 may store the topic model received from the request destination device in the storage portion 140 and use the stored topic model in the above-described process on the individual utterance text.

In the above-described display example, the display and non-display of the display information can be switched in accordance with an operation. Therefore, the display processing portion 134 may count a display request frequency, which is a frequency at which an instruction for displaying display information of a numerical value related to each word or phrase of a prescribed topic included in display text is issued and may store the counted display request frequency in the storage portion 140. The display processing portion 134 may cause display information of a numerical value related to a word or a phrase whose display request frequency stored in the storage portion 140 exceeds a prescribed display determination threshold value to be displayed in association with display text and may not cause display information about a word or a phrase whose display request frequency is less than or equal to the prescribed display determination threshold value to be displayed.

Here, the display processing portion 134 may also store the display request frequency counted for each word or phrase as a part of the topic model (see FIG. 12). Thereby, the display processing portion 134 can determine a display request frequency corresponding to the identified word or phrase with reference to the topic model and determine the necessity of display of the display information. Here, the display request frequency is updated by the issuance of an instruction for displaying the display information.

The display processing portion 134 may count a deletion request frequency, which is a frequency at which an instruction for deleting display information of a numerical value related to each word or phrase of a prescribed topic included in the reference text is issued and may store the counted deletion request frequency in the storage portion 140. The display processing portion 134 may not cause display information of a numerical value related to a word or a phrase whose display request frequency stored in the storage portion 140 exceeds a prescribed deletion determination threshold value to be displayed in association with display text and may cause display information about a word or a phrase whose deletion request frequency is less than or equal to the prescribed deletion determination threshold value to be displayed. The display processing portion 134 may store the counted deletion request frequency included in the topic model like the display request frequency and determine the necessity of display of the display information with reference to the topic model.

Thereby, the necessity of showing a numerical value related to the utterance text is controlled in accordance with a trend of use of the user.

### (Display Process)

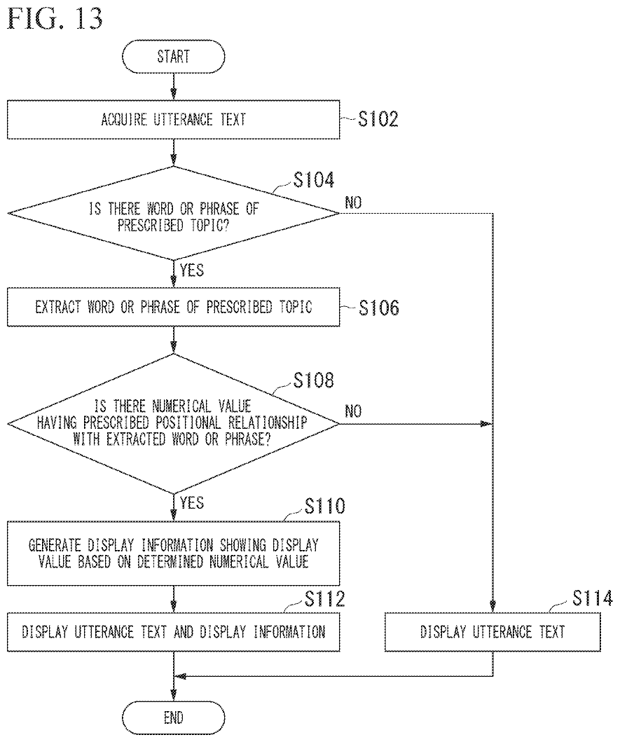

Next, an example of a process of displaying utterance text according to the present embodiment will be described. FIG. 13 is a flowchart showing an example of the process of displaying utterance text according to the present embodiment.

(Step S102) The text processing portion 120 acquires first text information input from the speech recognition portion 114 or second text information input from the text acquisition portion 118 as display text information indicating the utterance text (utterance text acquisition). Subsequently, the process proceeds to the processing of step S104.

(Step S104) The topic analysis portion 124 attempts to detect a word or a phrase related to a prescribed topic from the utterance text indicated in the acquired display text information with reference to topic data and determines whether or not there is a word or a phrase related to a prescribed topic in the utterance text. When it is determined that there is a word or phrase of a prescribed topic (YES in step S104), the process proceeds to the processing of step S104. When it is determined there is no word or phrase of a prescribed topic (NO in step S104), the process proceeds to the processing of step S114.

(Step S106) The topic analysis portion 124 extracts a word, a phrase, or a synonym of the prescribed topic from the utterance text. Subsequently, the process proceeds to the processing of step S108.

(Step S108) The topic analysis portion 124 searches for a numerical value having a prescribed positional relationship from the extracted word, phrase, or synonym in the utterance text. The topic analysis portion 124 determines whether or not there is a numerical value having a prescribed positional relationship from the extracted word, phrase, or synonym. When it is determined that there is a numerical value (YES in step S108), the process proceeds to the processing of step S110. When it is determined that there is no numerical value (NO in step S108), the process proceeds to the processing of step S114.

(Step S110) The topic analysis portion 124 determines a determined numerical value or another numerical value derived from the numerical value as a display value, and outputs display value information including the determined display value to the display processing portion 134.

The display processing portion 134 generates display information that shows the numerical value indicated in the display value information. Subsequently, the process proceeds to the processing of step S112.

(Step S112) The display processing portion 134 uses the utterance text as the display text and causes one or both of the display portion 190 and the display portion 290 to display the display text in association with the generated display information. Subsequently, the process shown in FIG. 13 ends.

(Step S114) The display processing portion 134 uses the utterance text as the display text, includes the display text in the display screen, and causes one or both of the display portion 190 and the display portion 290 to display the display text. Subsequently, the process shown in FIG. 13 ends.

As described above, the conversation support device 100 according to the present embodiment includes the speech recognition portion 114 configured to generate utterance text representing utterance content by performing a speech recognition process on speech data. The conversation support device 100 includes the topic analysis portion 124 configured to identify a word or a phrase of a prescribed topic and a numerical value having a prescribed positional relationship with the word or the phrase from the utterance text. The conversation support device 100 includes the display processing portion 134 configured to cause the display portion 190 or 290 to display display information in which the identified numerical value or a numerical value derived from the numerical value is shown as a display value in association with the utterance text.

According to the above configuration, the numerical value related to the prescribed topic included in the utterance text is identified from the utterance text indicating the utterance content and the display value based on the identified numerical value is shown in association with the utterance text. Thus, the user who has access to the display information can intuitively understand the significance of the numerical value uttered in relation to the topic of the utterance content. Consequently, the understanding of the entire utterance content is promoted.

The display processing portion 134 may generate display information in which the display value (for example, a progress rate) is shown in a format (for example, a pie chart) corresponding to the identified word or the phrase.

According to the above configuration, the display value is shown in a format suitable for the topic or the target object indicated in the identified word or phrase. Because the significance of the numerical value, which has been uttered, is emphasized, understanding of the utterance content is promoted.

The topic analysis portion 124 may extract a unit of a numerical value having a prescribed positional relationship with the identified word or phrase and the numerical value associated with the unit from the utterance text.

According to the above configuration, because the numerical value related to the unit appearing simultaneously with the identified word or phrase in the utterance text is identified, the numerical value related to the topic or the target object related to the word or phrase can be accurately extracted.

The topic analysis portion 124 may extract a reference quantity and a target quantity from the utterance text using predetermined sentence pattern information indicating a relationship between the reference quantity and the target quantity of an object indicated in the identified word or phrase, and may determine a ratio of the target quantity to the reference quantity as the display value.

According to the above configuration, the ratio obtained by normalizing the target quantity with respect to the reference quantity of the object related to the identified word or phrase is shown as the display value. Thus, the user can easily understand the significance of a substantial value of the target quantity in relation to the reference quantity.

The topic analysis portion 124 may extract a second word or phrase indicating a target object of a period and a date and time including at least one numerical value related to the second word or phrase as a starting point of the period from the utterance text, the period being related to the topic. The display processing portion 134 may generate the display information indicating a prescribed period that starts from the starting point that has been extracted.

According to the above configuration, at least a numerical value for identifying the starting point of the period related to the object that has been uttered is extracted from the utterance text, and the period starting from the starting point indicated by the extracted numerical value is shown. Thus, the user can be allowed to easily understand that the starting point of the period of the target object forms the topic of the utterance content according to the display information.

When an ending point of the period that has been displayed is not determined, the display processing portion 134 may cause the display portion 190 or 290 to display guidance information indicating that the ending point is not determined.

According to the above configuration, the user is notified that the ending point of the period in the displayed guidance information is a provisional ending point. It is possible to prompt the user to identify the ending point.

The display processing portion 134 may determine the necessity of an output (display) of the display information on the basis of a necessity indication trend (for example, a display request frequency or a deletion request frequency) for each word or phrase, the necessity of the display information being indicated in accordance with an operation.

According to the above configuration, the display information is displayed with respect to the topic or the object related to the word or the phrase whose display of the display information tends to be required and the display information is not displayed with respect to the topic or the object related to the word or the phrase whose display tends to be rejected. Thus, the necessity of the display information is controlled in accordance with preferences of the user regarding the necessity of the display according to the topic or the target object of the utterance content.

The topic analysis portion 124 may determine the word or the phrase related to the topic conveyed in the utterance text using a topic model indicating a probability of appearance of each word or phrase in each topic.

According to the above configuration, the topic analysis portion 124 can determine a word or a phrase related to the topic of the utterance content conveyed in the utterance text in a simple process.

Although one embodiment of the present invention has been described in detail with reference to the drawings, the specific configuration is not limited to the above and various design changes and the like are made without departing from the spirit and scope of the present invention.

For example, the sound collection portion 170, the operation portion 180, and the display portion 190 may not be integrated with the conversation support device 100 or may be separate from the conversation support device 100 if anyone or a combination thereof can make a connection so that various types of data can be transmitted and received wirelessly or by wire.

The speech analysis portion 112 may acquire speech data from the sound collection portion 270 of the terminal device 200 instead of the sound collection portion 170 or together with the sound collection portion 170.

The text acquisition portion 118 may acquire the second text information based on the operation signal input from the operation portion 180 of its own device instead of the operation portion 280 of the terminal device 200.

When the text acquisition portion 118 does not acquire the second text information from the terminal device 200, display screen data may not be transmitted to the terminal device 200.

A shape of the display frame surrounding the display text is not limited to the balloons shown in the examples of FIGS. 4, 6, and 8 and may be any shape such as an ellipse, a rectangle, a parallelogram, or a cloud shape as long as the display text can be accommodated. A horizontal width and a vertical height of the individual display frame may be unified to given values. In this case, an amount of vertical movement when new display text is assigned is equal to the vertical height and a spacing between display frames adjacent to each other. The display text may be displayed on a new line for each utterance without being accommodated and displayed in the display frame. In addition, the positions and sizes of display elements such as buttons and input fields constituting the display screen are arbitrary and some of the above display elements may be omitted. Display elements not shown in the examples of FIGS. 4, 6, and 8 may be included. The wording attached to the display screen or the name of the display element can be arbitrarily set without departing from the spirit and scope of the embodiment of the present application.

What is claimed is:

1. A conversation support device comprising:
a speech recognition portion configured to generate utterance text representing utterance content by performing a speech recognition process on speech data;
a topic analysis portion configured to identify a word or a phrase of a prescribed topic and a numerical value having a prescribed positional relationship with the word or the phrase from the utterance text; and
a display processing portion configured to cause a display portion to display display information in which the numerical value or a numerical value derived from the numerical value is shown as a display value in association with the utterance text.

2. The conversation support device according to claim 1, wherein the display processing portion generates display information in which the display value is shown in a format corresponding to the word or the phrase.

3. The conversation support device according to claim 1, wherein the topic analysis portion extracts a unit of a numerical value having a prescribed positional relationship with the word or the phrase and the numerical value associated with the unit from the utterance text.

4. The conversation support device according to claim 1,
wherein the topic analysis portion extracts a reference quantity and a target quantity from the utterance text using predetermined sentence pattern information indicating a relationship between the reference quantity and the target quantity of an object indicated in the word or the phrase, and
wherein the topic analysis portion determines a ratio of the target quantity to the reference quantity as the display value.

5. The conversation support device according to claim 1,
wherein the topic analysis portion extracts a second word or phrase indicating a target object of a period and a date and time including at least one numerical value related to the second word or phrase as a starting point of the period from the utterance text, the period being related to the topic, and
wherein the display processing portion generates the display information indicating a prescribed period that starts from the starting point.

6. The conversation support device according to claim 5, wherein, when an ending point of the period is not determined, the display processing portion causes the display portion to display guidance information indicating that the ending point is not determined.

7. The conversation support device according to claim 1, wherein the display processing portion determines the necessity of an output of the display information on the basis of a necessity indication trend for each word or phrase, the necessity of the display information being indicated in accordance with an operation.

8. The conversation support device according to claim 1, wherein the topic analysis portion determines the word or the phrase related to the topic conveyed in the utterance text using a topic model indicating a probability of appearance of each word or phrase in each topic.

9. A conversation support system comprising:
the conversation support device according to claim 1; and
a terminal device,
wherein the terminal device includes
an operation portion configured to receive an operation, and
a communication portion configured to transmit the operation to the conversation support device.

10. A computer-readable non-transitory storage medium storing a program for causing a computer to function as the conversation support device according to claim 1.

11. A conversation support method for use in a conversation support device, the conversation support method comprising:
a speech recognition process of generating utterance text representing utterance content by performing a speech recognition process on speech data;
a topic analysis process of identifying a word or a phrase of a prescribed topic and a numerical value having a prescribed positional relationship with the word or the phrase from the utterance text; and
a display processing process of causing a display portion to display display information in which the numerical value or a numerical value derived from the numerical value is shown as a display value in association with the utterance text.
